(19) United States
(12) Patent Application Publication
(10) Pub. No.: US 2024/0194361 A1
(43) Pub. Date: Jun. 13, 2024

(54) SYSTEMS AND METHODS OF THERMOELECTRIC COOLING IN POWER PLANTS

(71) Applicant: GE-Hitachi Nuclear Energy Americas LLC, Wilmington, NC (US)

(72) Inventors: Hanying Liu, Wilmington, NC (US); Charles L. Heck, Leland, NC (US)

(21) Appl. No.: 18/077,293

(22) Filed: Dec. 8, 2022

(51) Int. Cl. G21C 15/02; F25B 21/02; G21C 15/28

(52) U.S. Cl. CPC G21C 15/02; F25B 21/02; G21C 15/28

(57) ABSTRACT

Systems and methods provide a thermoelectric cooler to cool a variety of high-energy power plant geometries and configurations. The thermoelectric cooler is thermally connected at heat sink side to a component to be cooled, including coolant structural components, for the plant. A heat rejection side of the cooler is thermally connected to a heat sink, including ambient air, a plant structure, or a fluid coolant. Electricity may be selectively applied to the cooler to generate a temperature difference and heat flux between the heat sinking side and heat rejection side. Radiation-resilient materials may be used in the cooler in the case of nuclear installations. Power sources include batteries, plant or grid electrical power, dedicated generators, or any other power source, potentially at relatively low ratings, such as only hundreds of watts, that will provide desired thermoelectric cooling.

### BACKGROUND

Thermoelectric coolers rely on the Peltier effect (or collective Peltier-Seebeck phenomenon) whereby a temperature gradient is achieved on opposite sides of a thermocouple subject to electric voltage. FIG. 1 is an example of a thermoelectric cooler 10 using an array of thermoelectric cells. As shown in FIG. 1, thermoelectric cooler 10 may use differing materials in each cell joined in a thermocouple. For example, an array of n-type semiconductors 11 and p-type semiconductors 12 may be alternately arranged on conductors 15 and function as thermoelectric cells. Semiconductors 11 and 12 may be several materials, such as bismuth telluride, lead telluride, silicon germanium, and/or bismuth antimonide alloys. Conductive plates 16 may be attached on opposite sides of conductors 15. Voltage source 13 may connect to the array via plates 16, setting up a voltage potential across all pairs of semiconductors 11 and 12. The Peltier effect in different semiconductors 11 and 12 causes cooling on top side 17 and heating on bottom side 18 of cooler 10. The resulting temperature gradient between top side 17 and bottom side 18 may be sufficiently large such that heat is transported between heat sources and sinks on either side of plates 16.

Thermoelectric coolers are typically used where electrical connections can be provided with ease, such as in computer systems and consumer cooling devices. For example, U.S. Pat. No. 4,581,898 to Preis illustrates an early thermoelectric cooler for consumer products; U.S. Pat. No. 5,713,208 to Chen et al. illustrates a basic configuration for a computer thermoelectric cooler, and U.S. Pat. No. 6,000,225 to Ghoshal teaches use in a radial configuration. These different types and shapes of thermoelectric cooling cells, and the entirety of these patents, are incorporated by reference herein.

This background provides a useful baseline or starting point from which to better understand some example embodiments discussed below. Except for any clearly-identified third-party subject matter, likely separately submitted, this Background and any figures are by the Inventor(s), created for purposes of this application. Nothing in this application is necessarily known or represented as prior art.

### SUMMARY

Example embodiments include a thermoelectric cooler, which uses the so-called Peltier and/or Seebeck effects to relate electricity and temperature differentials, in extremely high-temperature and/or high-energy power-production environments, including 100-megawatt thermal or greater commercial power plants where conventionally only active, flowed coolant and/or refrigerant-compressor-type coolant methods have been used. The thermoelectric cooler is thermally connected at one side to the component, which allows excess heat in the component to readily flow to the cooler. Another side of the cooler is thermally connected to a heat sink of the plant. Electricity may be connected to the cooler such that it generates a temperature difference and heat flux between its sides. As long as a temperature of the heat sink plus the temperature difference generated by the cooler is cooler than the component, heat will be rejected from the component to the heat sink by the cooler.

Example methods install and/or operate thermoelectric cooler(s) in otherwise challenging power plant locations. For example, a cooler may be sized and shaped to transfer heat from a coolant structural component for the plant that is heated by a heat-exchange medium, such as a reactor pressure vessel or penetration for the same in a nuclear power plant. Materials that do not substantially absorb or degrade in nuclear environments may make up thermoelectric coolers in such examples needing radiation-resilient materials. The heat sink in these examples may be containment air or a structure that is cooler and/or conducts heat away such as a containment or drywell wall. Similarly, example methods may make use of the surrounding environment for a heat sink, including atmospheric air and nearby rivers, lakes, and coolant pools. Thermoelectric cooler(s) can further be configured based on cooling need, electricity available, and installation location. For example, an example method may select a thermoelectric cooler rated for 200 watts or less of electric power and power the same with a local battery, such as a 10-20V battery installed next to the cooler that can power the same for many hours, plant DC electricity, and/or a generator potentially operating on plant-generated (waste) heat.

### BRIEF DESCRIPTIONS OF THE DRAWINGS

Example embodiments will become more apparent by describing, in detail, the attached drawings, wherein similar elements are represented by similar reference numerals. The drawings serve purposes of illustration only and thus do not limit example embodiments herein. Elements in these drawings may be to scale with one another and exactly depict shapes, positions, operations, and/or wording of example embodiments, or some or all elements may be out of scale or embellished to show alternative proportions and details.

FIG. 1 is an illustration of a related art thermoelectric array.

FIG. 2 is a flow chart illustrating an example method.

FIG. 3 is a schematic of an example embodiment reactor cooling system.

### DETAILED DESCRIPTION

Because this is a patent document, general broad rules of construction should be applied when reading it. Everything described and shown in this document is an example of subject matter falling within the scope of the claims, appended below. Any specific structural and functional details disclosed herein are merely for purposes of describing how to make and use examples. Several different embodiments and methods not specifically disclosed herein may fall within the claim scope; as such, the claims may be embodied in many alternate forms and should not be construed as limited to only examples set forth herein.

Membership terms like “comprises,” “includes,” “has,” or “with” reflect the presence of stated features, characteristics, steps, operations, elements, and/or components, but do not themselves preclude the presence or addition of one or more other features, characteristics, steps, operations, elements, components, and/or groups thereof. Rather, exclusive modifiers like “only” or “singular” may preclude presence or addition of other subject matter in modified terms. The use of permissive terms like “may” or “can” reflect optionality such that modified terms are not necessarily present, but absence of permissive terms does not reflect compulsion. In listing items in example embodiments, conjunctions and inclusive terms like “and,” “with,” and “or” include all combinations of one or more of the listed items without exclusion of non-listed items. The use of “etc.” is defined as “et cetera” and indicates the inclusion of all other elements belonging to the same group of the preceding items, in any “and/or” combination(s). Modifiers “first,” “second,” “another,” etc. do not confine modified items to any order. These terms are used only to distinguish one element from another; where there are “second” or higher ordinals, there merely must be that many number of elements, without necessarily any difference or other relationship among those elements.

When an element is related, such as by being “connected,” “coupled,” “on,” “attached,” “fixed,” etc., to another element, it can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.).

As used herein, singular forms like “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to the same previously-introduced term. Relative terms such as “almost” or “more” and terms of degree such as “approximately” or “substantially” reflect 10% variance in modified values or, where understood by the skilled artisan in the technological context, the full range of imprecision that still achieves functionality of modified terms. Precision and non-variance are expressed by contrary terms like “exactly.”

As used herein, “axial” and “vertical” directions are the same up or down directions oriented along the major axis of a nuclear reactor, often in a direction oriented with gravity. “Transverse” directions are perpendicular to the “axial” and are side-to-side directions at a particular axial height, whereas “radial” is a specific transverse direction extending perpendicular to and directly away from the major axis of the nuclear reactor.

The structures and operations discussed below may occur out of the order described and/or noted in the figures. For example, two operations and/or figures shown in succession may in fact be executed concurrently or may be executed in the reverse order, depending upon the functionality/acts involved. Similarly, individual operations within example methods described below may be executed repetitively, individually or sequentially, so as to provide looping or other series of operations aside from exact operations described below. It should be presumed that any embodiment or method having features and functionality described below, in any workable combination, falls within the scope of example embodiments.

The inventors have recognized that existing and new power plant designs may use reduced dimensions to optimize land use and allow modularity. For example, in conventional commercial nuclear power plants and next generation reactor designs, smaller spaces, with potentially little free volume or components in direct contact, may be necessary at important fluid and mechanical junctures, such as around reactor penetrations in a limited containment space or around safety systems managing coolant for the reactor. Smaller spaces may be unable to accommodate cooling systems, especially active systems using fans, pumps, compressors, refrigerant, etc. to drive coolant and/or pump heat, due to the size, connections, powering requirements, etc. of active cooling systems. Smaller spaces may also have limited convection exposure to ambient air or heat sink. Especially where components are exposed to heat from a principal power source, such as heat transferred from a plant coolant, this lack of cooling may represent increased failure potential, shortened lifespan, and/or degraded performance, negatively impacting plant integrity and/or electrical generation. Thermoelectric coolers, however, have been configured for small-scale consumer environments with heat transfer perhaps approaching a megawatt thermal, not in 100+megawatt thermal industrial plants. To overcome these newly-recognized problems as well as others, the inventors have developed example embodiments and methods described below to address these and other problems recognized by the inventors with unique solutions enabled by example embodiments.

The present invention is systems and methods of thermoelectric cooling in power plants producing commercial power. In contrast to the present invention, the few example embodiments and example methods discussed below illustrate just a subset of the variety of different configurations that can be used as and/or in connection with the present invention.

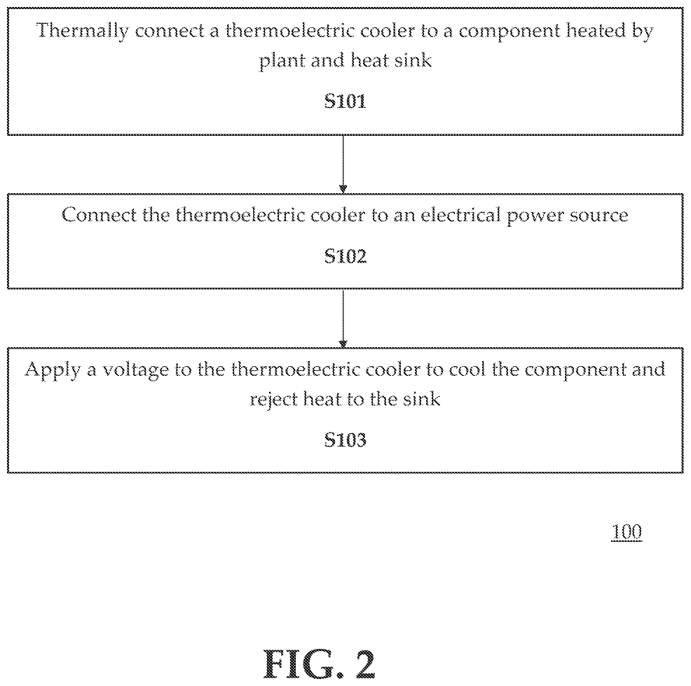

FIG. 2 is a flow chart illustrating an example method 100 of installing and/or using one or more thermoelectric coolers in a commercial power plant, including a large-scale installation generating grid electricity. The plant may be, for example, a 100+megawatt-thermal power plant with a fluid coolant transferring energy from an enthalpy source like a furnace, boiler, nuclear reactor, gas turbine, etc. As a further example, the plant may be a nuclear power plant housing a reactor generating heat through nuclear fission to power a turbine and generator, such as an existing commercial light water reactor like a BWR or PWR or a next-generation reactor like the BWRX-300 or Natrium or PRISM reactor. US Patent Publications 2018/0322966 to Hunt et al.; 2019/0006052 to Hunt et al.; 2019/0057785 to Hunt et al.; and 2020/0395135 to Dahlgren et al. show a few different plant designs where example methods are useable in new nuclear power designs and are incorporated by reference herein in their entireties. Example method 100 may be performed at any point in construction of the power plant or during operation of the same.

As seen in FIG. 2, example method 100 may include thermally connecting a thermoelectric cooler to a coolant structural component, electrical component, and/or any other structure in the power plant. As used herein, “coolant structural component” is defined as any structure heated above ambient temperatures primarily by heat from the enthalpy source in the plant, and excludes devices primarily being heated from electrical consumption, such as electronics, lights, etc. For example, coolant structural components may be piping carrying the plant's fluid coolant, emergency coolant valves, instrumentation lines, a condenser or heat exchanger, a reactor vessel, containment drywell and walls or supports in containment, etc., that are heated by energy developed in a nuclear core or from combustion of a powering fuel, for example. The fluid coolant may be any heat-exchange medium that transfers heat from the plant's primary enthalpy source, such as an exhaust gas, light water, liquid metal, helium, etc. used as a heat transfer medium for the source.

As used herein, “thermal communication” and “thermal connecting” are defined as placing the thermoelectric cooler on or near the component such that heat is readily conducted by the thermoelectric cooler away from the component, and without significant thermal insulation between the cooler and component. The connecting in S101 places a first, heat-sinking side of the thermoelectric cooler in thermal communication with the component and a second, heat-discharging side of the thermoelectric cooler in a heat sink for the plant. For example, the heat-sinking side may be a ceramic mounted directly to a component surface, a finned plate installed in ambient plant air heated by the enthalpy source, a cooling block connected to a fluid coolant line flowing through plant electronics, etc. For example, the heat-discharging side may be thermally connected to any heat sink, such as environmental air, a coolant pool, ground, cooled ambient air in the plant, a cold block, etc.

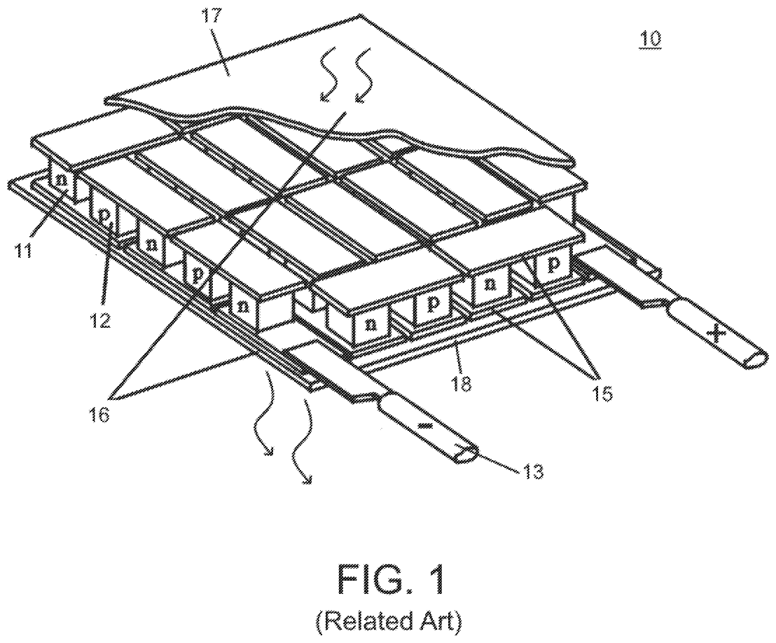

The thermoelectric cooler may be of any shape and capacity, as described in connection with FIG. 1. For example, the thermoelectric cooler may include a single cell of a thermocouple, or be an array of several cells disposed between conductive surfaces of any geometry. This includes curved, stepped, and cut-out surface shapes specifically matched to component surfaces. The cooler may be fitted to curved or complex surfaces simply by changing the shape of the cooler array. If the cooler is small, it may fit in areas having small clearances on the scale of an inch or less. In this way, the thermoelectric cooler in S101 may be placed into space-restricted and small areas common in power plants where conventional cooling conduits cannot be placed and ambient air may be excluded or poorly circulate. The thermoelectric cooler may have any other desired configuration and cooling or power capacity. For example, a single-stage array operating on 12-16V may provide a 60-70° temperature difference from component surface to ambient air or another heat sink. Similarly, multi-stage thermoelectric coolers operating on different powers may provide even larger temperature differences between hot and cold sides.

The thermoelectric cooler may use any materials, including semiconductors like silicon carbide, bismuth telluride, lead telluride, silicon germanium, and bismuth antimonide alloys. If used in a nuclear power plant, example methods may use thermoelectric coolers fabricated of materials that are compatible with an operating nuclear reactor environment, including radiation-resilient materials that maintain their physical characteristics when exposed to high-temperature fluids and radiation without substantially changing in physical properties, such as becoming substantially radioactive, melting, brittling, retaining/adsorbing radioactive particulates, etc. For example, silicon carbide may be used for semiconductor materials with little radiation or elevated temperature interaction, and ceramics or metals such as stainless steels and iron alloys, nickel alloys, zirconium alloys, etc., including austenitic stainless steels 304 or 316, XM-19, Alloy 600, etc., are useable for various thermoelectric cooler components including conductors, mounts, wiring, etc. Similarly, direct connections between distinct parts and all other direct contact points may be lubricated, insulated, and/or fabricated of alternating or otherwise compatible materials to prevent seizing, fouling, metal-on-metal reactions, conductive heat loss, etc.

As further specific examples of the connecting in S101, the heat sink side of a thermoelectric cooler may be connected to motor controls and a valve body for a safety valve on a coolant conduit in the power plant. Or, for example, a thermoelectric cooler may be placed into the wall of a turbine building to transfer heat developed by fluid coolant flowing through the turbine from the ambient air in contact with the cold side of the cooler to the outside environment in contact with the hot side. Or, for example, the heat sink side of a thermoelectric cooler may be positioned in a containment drywell space of a nuclear power plant, with the hot side mounted on a concrete containment building or other heat-absorbing structure. Or, for example, a thermoelectric cooler may be placed into a control cabinet in a nuclear power plant control room with cold side thermally connected to the cabinet electronics and a hot side in ambient air.

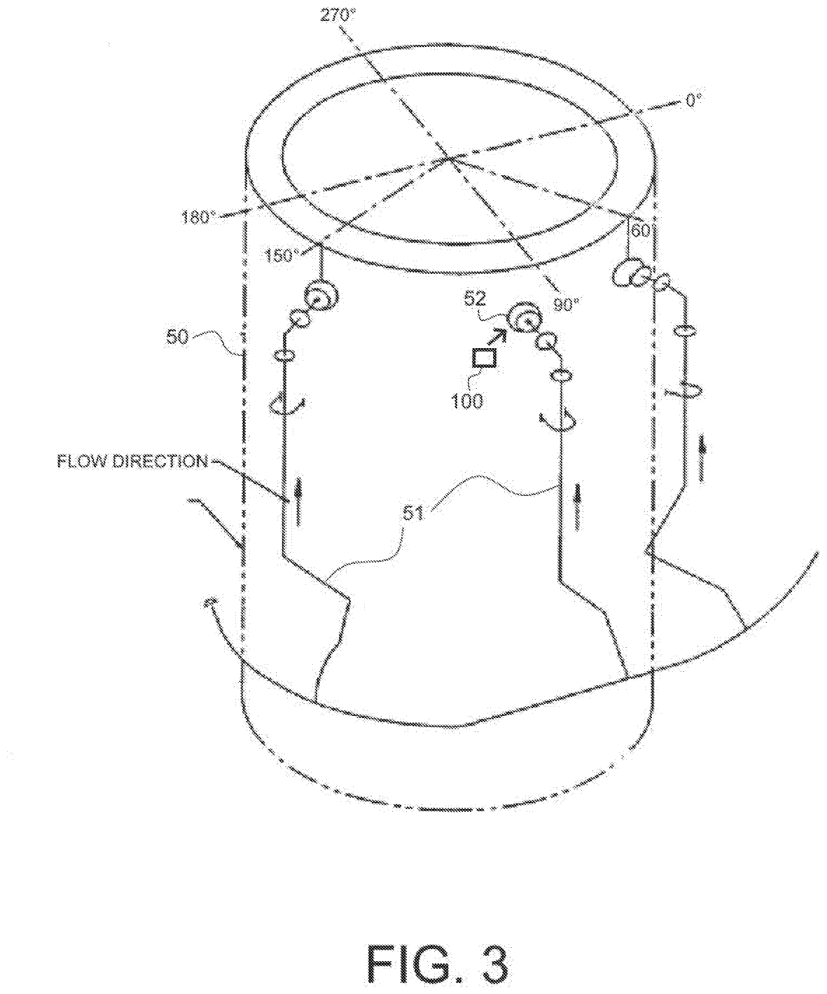

Or, for example, as shown in FIG. 3, several hot spots may develop around the exterior of reactor pressure vessel 50. Especially around coolant piping 51 and vessel 50, there may be little clearance or other space inside of a containment building. Penetrations 52 for vessel 50 may become especially hot and be sensitive to damage, such as cracking or creep failure, due to overheating. Thermoelectric cooler 110 may be installed in S101 on penetration 52. For example, a heat sinking side of cooler 110 may be shaped to penetration 52 and affixed to the same outside vessel 50, even in small clearance spaces around piping 51 on the scale of inches. A heat rejection side of cooler 110 may be exposed to ambient air inside the containment, to which it may reject heat, potentially with a finned surface or conductive connection to a colder or ground structure. An electrical power source may be provided by battery 120 or electrical connection to the plant grid, for example. As seen, thermoelectric coolers may be thermally connected to a variety of components, including electronics, ambient air, and coolant structural components, in commercial power plants to provide desired cooling and heat transfer to these components.

As shown in FIG. 2, the thermoelectric cooler is provided electrical power in S102 by being connected to a power source. Because of their flexibility in design, even highest-capacity coolers covering entire component surfaces or providing room cooling may operate from plant-provided DC power, such as a 12-16V connection providing only 3-6 amps of current. Any other electrical connection is equally possible, such as a 60 mV connection providing 1000 amps of current. Such power sources may provide anywhere from milliwatts of heat transfer to a hundred kilowatts of heat transfer from a single cooler, adaptable based on application and anticipated temperatures and heat load of the cooled component. While plant or grid electrical power is useable in S102, local battery power may also be used and provide hours of operation to thermoelectric coolers consuming little power.

Still further in S102, the thermoelectric cooler may be connected to an emergency or “self-powering” source that does not require grid or other large electrical supply, because of the relatively low power requirements of thermoelectric coolers. For example, lower-power generators of tens or hundreds electrical wattage may operate on plant rejected heat or decay heat. This can provide sufficient power to operate significant thermoelectric cooling capacity to enhance heat rejection on critical components and plant areas subject to overheat. For example, the generators disclosed in U.S. Pat. Nos. 10,311,985; 11,322,267 to Thinguldstad et al., incorporated herein by reference in their entireties, may be connected to thermoelectric coolers in S102 and provide power to the same. Or, for example, a small, low-pressure turbine and generator may be installed at a heat rejection point, such as at a condenser, or on a coolant pool or building housing the same, to generate sufficient power for thermoelectric cooling from a lower quality coolant fluid or boiling of the coolant pool. In this way, through batteries, grid or plant power, and local smaller-scale generation, thermoelectric coolers may be powered in S102 and provide significant cooling to plant components at any desired time.

As shown in FIG. 2, the thermoelectric cooler is actuated in S103 to provide thermoelectric cooling and resulting improved heat transfer away from the connected component(s). The actuation generates a temperature difference between the hot and cold sides, enhancing heat absorption and rejection through the cooler, potentially beyond what may be available through radiation, conductive, and convective transfer from the installed component. The temperature difference and heat flux may be of any desired value and/or controlled within a range. For example, coolers may operate at just a few degrees Celsius difference or up to 70 degrees Celsius difference, through proper powering and array staging.

The actuation in S103 may be continuous or at desired times. For example, the thermoelectric cooler may constantly draw power and enhance heat transfer away from a thermally connected component to a heat sink at a steady rate. Or, for example, the thermoelectric cooler may be powered on and cool only at selected times, or may increase cooling or decrease cooling only at selected times through selective powering of subsets of cooling cells. For example, the thermoelectric cooler may be paired with a temperature sensor and automatically activate at a threshold temperature of a cooled component in S103. Or, for example, a manual activation locally or through a command signal from a control room may activate the thermoelectric cooler in S103. Still further, the thermoelectric cooler may activate in S103 whenever there is electrical power, such as whenever an emergency turbine and/or generator are running in transient conditions associated with a need for enhanced heat transfer.

Through their small size, adaptable shape, and low power requirements, thermoelectric coolers may be installed in nearly any power plant location, and fitted to be in thermal connection with nearly any desired component in example methods. Further, the lack of moving parts, nonuse of refrigerant or compressor or pressure seals, resiliency of materials, and low power requirements of thermoelectric coolers may ensure their operation in example methods even during challenging conditions, including overheating, natural disaster, loss of plant power, after extended periods of nonuse, and/or other physical disruption. Even in higher-temperature and—radiation environments, hardened materials and/or shielding may be used in thermoelectric coolers to ensure their reliable operation. In this way, example methods may ensure that temperature excursions or cycling in any plant component may be mitigated or prevented, along with performance degradation that accompanies the same.

Some example embodiments and methods thus being described, it will be appreciated by one skilled in the art that examples may be varied through routine experimentation and without further inventive activity. For example, although commercial nuclear power plant components are the target of some example methods, it is understood that other power plants are useable with example embodiments and methods. Variations are not to be regarded as departure from the spirit and scope of the example embodiments, and all such modifications as would be obvious to one skilled in the art are intended to be included within the scope of the following claims.

1. A method of cooling a component in a 100-megawatt thermal or greater commercial power plant, the method comprising:
connecting a thermoelectric cooler to the component in the power plant, wherein the connecting places a first side of the thermoelectric cooler in thermal communication with the component and a second side of the thermoelectric cooler in thermal communication with a heat sink for the power plant; and
connecting the thermoelectric cooler to an electrical power source.

2. The method of claim 1, further comprising:
applying a voltage to cells of the thermoelectric cooler to cool the first side and heat the second side.

3. The method of claim 1, wherein the component is a coolant structural component for the plant.

4. The method of claim 1, wherein the plant is a nuclear power plant, and wherein the thermoelectric cooler uses only radiation-resilient materials.

5. The method of claim 4, wherein the thermoelectric cooler uses silicon carbide as cells of the thermoelectric cooler.

6. The method of claim 4, wherein the heat sink is ambient air inside a containment building for a nuclear reactor of the nuclear power plant.

7. The method of claim 6, wherein the component is a penetration for a nuclear pressure vessel, and wherein the thermoelectric cooler directly contacts the penetration.

8. The method of claim 4, wherein the heat sink is environment surrounding the nuclear power plant.

9. The method of claim 1, wherein the thermoelectric cooler operates on 1-10 amps and less than 200 watts electric power.

10. The method of claim 1, wherein the power source is at least one of an electrical supply for the plant, a battery, and a maximum 200-watt electrical generator installed in the plant.

11. A method of cooling a component in a 100-megawatt thermal or greater commercial power plant, the method comprising:
applying a voltage to a thermoelectric cooler connected to the component in the power plant, wherein the applying reduces a temperature of a first side of the thermoelectric cooler in thermal communication with the component and increases a temperature of a second side of the thermoelectric cooler in thermal communication with a heat sink for the power plant.

12. The method of claim 11, wherein the component is a coolant structural component for the plant.

13. The method of claim 11, wherein the plant is a nuclear power plant, and wherein the thermoelectric cooler uses only radiation-resilient materials.

14. The method of claim 13, wherein the thermoelectric cooler uses silicon carbide as cells of the thermoelectric cooler.

15. The method of claim 13, wherein the heat sink is ambient air inside a containment building for a nuclear reactor of the nuclear power plant.

16. The method of claim 15, wherein the component is a penetration for a nuclear pressure vessel, and wherein the thermoelectric cooler directly contacts the penetration.

17. The method of claim 13, wherein the heat sink is environment surrounding the nuclear power plant.

18. The method of claim 11, wherein the thermoelectric cooler operates on 1-10 amps and less than 200 watts electric power.

19. The method of claim 11, wherein the power source is at least one of an electrical supply for the plant, a battery, and a maximum 200-watt electrical generator installed in the plant.

20. A system for thermoelectric cooling the system comprising:
a component in a 100-megawatt thermal or greater commercial power plant;
a thermoelectric cooler connected to the component such that a first side of the thermoelectric cooler is in thermal communication with the component and a second side of the thermoelectric cooler is in thermal communication with a heat sink for the power plant; and
an electrical power source connected to the thermoelectric cooler.
